(19) United States
(12) Patent Application Publication
(10) Pub. No.: US 2014/0165022 A1
(43) Pub. Date: Jun. 12, 2014

(54) RELATIVE TIMING ARCHITECTURE

(71) Applicant: KENNETH S. STEVENS, SALT LAKE CITY, UT (US)

(72) Inventor: KENNETH S. STEVENS, SALT LAKE CITY, UT (US)

(21) Appl. No.: 13/945,843

(22) Filed: Jul. 18, 2013

Related U.S. Application Data
(60) Provisional application No. 61/672,865, filed on Jul. 18, 2012.
(60) Provisional application No. 61/673,849, filed on Jul. 20, 2012.

(51) Int. Cl. G06F 17/50

(52) U.S. Cl. CPC G06F 17/5031
USPC 716/134

(57) ABSTRACT

Technology for generating a relative timing architecture using a relative timed module is disclosed. In an example, an electronic design automation (EDA) tool enabled for clocked tool flows can include computer circuitry configured to: Generate a hardware description language (HDL) integrated circuit (IC) architecture using the relative timed module; map a relative timing constraint on to a relative timed instance of the relative timed module; and generate a timing target for each relative timing constraint.

### RELATED APPLICATIONS

This application claims the benefit of and hereby incorporates by reference U.S. Provisional Patent Application Ser. No. 61/672,865, entitled “Method for Characterizing Timed Circuit Modules for Compatibility with Clocked EDA Tools and Flows”, filed Jul. 18, 2012. This application claims the benefit of and hereby incorporates by reference U.S. Provisional Patent Application Ser. No. 61/673,849, entitled “Method for Timing Driven Optimization of IC Systems from Timing Characterized Modules using Clocked EDA Tools”, filed Jul. 20, 2012. This application claims the benefit of and hereby incorporates by reference co-pending U.S. patent application Ser. No. 13/945,775, entitled “RELATIVE TIMING CHARACTERIZATION”, filed Jul. 18, 2013.

### BACKGROUND

Circuit timing can impact the power, performance, noise, and area of a circuit. Timing can be adjusted by many alternative circuit design styles, which can provide benefits over industry standard clocked design methods and technology. Timing can also be a primary impediment to the commercialization and adoption for these alternative circuits. Asynchronous circuit design is an example of a circuit family that uses alternative timing. At a circuit and architectural level, asynchronous design uses a continuous timing model, whereas clocked design uses a discrete model of time based on clock cycles.

Two general methods for signal sequencing have emerged in the design community: Clocked and asynchronous. Clocked design is founded upon frequency based protocols that define discrete clock periods. Clocked methods contain combinational logic (CL) between latches or flops creating pipeline stages that are controlled by a common frequency. All other methods besides clocked methods can be considered “asynchronous”, including but not limited to methods that employ handshake protocols, self-resetting domino circuits, and embedded sequential elements, such as static random-access memory (SRAM), dynamic random-access memory (DRAM), read-only memory (ROM), or programmable logic arrays (PLA). Asynchronous elements can contain state-holding circuits, such as sequential controllers, domino gates, or memory elements. The arrival of inputs to an asynchronous circuit may not be based on a global clock frequency. Delays through an asynchronous circuit can vary based on function, application, manufacturing variations, and operating parameters, such as temperature and voltage fluctuations.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 illustrates a block diagram of an exemplary system for performing timing driven optimization using clocked electronic design automation (EDA) tools and flows for integrated circuit architectures and systems that employ modules characterized using relative timing in accordance with an example.

FIG. 2 illustrates a clocked pipeline in accordance with an example.

FIG. 3 illustrates a timed asynchronous pipeline in accordance with an example.

FIG. 4 illustrates a timed delay-insensitive asynchronous pipeline in accordance with an example.

FIG. 5 illustrates a flow chart of system design using precharacterized relative timed modules in accordance with an example.

FIG. 6 illustrates a process used to create a timing driven optimized system using electronic design automation (EDA) tools in accordance with an example.

FIG. 7 illustrates an efficient linear pipeline controller specification in accordance with an example.

FIG. 8 illustrates a circuit implementation of the efficient linear pipeline controller of FIG. 7 in accordance with an example.

FIG. 9 illustrates a Verilog implementation of an efficient linear pipeline controller using a 130 nanometer (nm) Artisan Library in accordance with an example.

FIG. 10 illustrates a representation of a path based relative timing constraints in accordance with an example.

FIG. 11 illustrates a set of relative timing constraints to hold for the efficient linear pipeline controller of FIG. 8 to conform to the linear pipeline controller specification in FIG. 7 in accordance with an example.

FIG. 12 illustrates a set of timing graph cuts that create a timing graph that is a directed acyclic graph (DAG) for the circuit of FIG. 9 in accordance with an example.

FIG. 13 illustrates a set of size only constraints for the controller of FIG. 9 in accordance with an example.

FIG. 14 illustrates a set of timing constraints for one of the controller modules of FIG. 3 to perform timing driven synthesis and optimization in accordance with an example.

FIG. 15 depicts a flow chart of a method for generating a relative timing architecture enabling use of clocked electronic design automation (EDA) tool flows in accordance with an example.

FIG. 16 depicts functionality of computer circuitry of an electronic design automation (EDA) tool for clocked tool flows configured for generating a relative timing architecture using a relative timed module in accordance with an example.

FIG. 17 illustrates a block diagram of an electronic design automation (EDA) tool for a clocked tool flow configured for relative timing architecture generation in accordance with an example.

Reference will now be made to the exemplary embodiments illustrated, and specific language will be used herein to describe the same. It will nevertheless be understood that no limitation of the scope of the invention is thereby intended.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular examples only and is not intended to be limiting.

### DEFINITIONS

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking, the nearness of completion can be so as to have the same overall result as if absolute and total completion were obtained. The use of “substantially” is equally applicable when used in a negative connotation to refer to the complete or near complete lack of an action, characteristic, property, state, structure, item, or result.

As used herein, the term “set” refers to a collection of elements, which can include any natural number of elements, including one, zero, or higher integer values.

Reference throughout this description to “an example” means that a particular feature, structure, or characteristic described in connection with the example is included in at least one embodiment of the present invention. Thus, appearances of the phrases “in an example” in various places throughout this specification are not necessarily all referring to the same embodiment.

The word “exemplary” is used herein to mean serving as an example, instance, or illustration. Any aspect or design described herein as “exemplary” is not necessarily to be construed as preferred or advantageous over other aspects or designs. Further, for the purposes of this disclosure and unless otherwise specified, “a” or “an” means “one or more”. The exemplary embodiments may be implemented as a method, apparatus, or article of manufacture using standard programming and/or engineering techniques to produce software, firmware, hardware, or any combination thereof to control a computer to implement the disclosed embodiments.

### EXAMPLES OF THE INVENTION

An initial overview of technology improvements is provided below and then specific technology examples are described in further detail later. This initial summary is intended to aid readers in understanding the technology more quickly, but is not intended to identify key features or essential features of the technology, nor is it intended to limit the scope of the claimed subject matter.

Clocked design dominates the electronic design automation (EDA) industry largely due to EDA's ability to enable high productivity. High productivity can be achieved by employing a methodology that restricts timing correctness to a very small number of predefined sequential cells, primarily the flip-flop and latch. These predefined cells can be characterized for the timing conditions that are used for design correctness, such as setup and hold times. The timing critical issues in a clocked design can converge at the flip-flops and latches.

This convergence has resulted in the timing requirements of the flip-flops and latches becoming directly integrated into the computer aided design (CAD) algorithms used in the EDA industry based on a clocked design methodology. While this directly integration of timing into algorithms simplifies clocked design, the algorithms can inhibit the application of circuits that employ other timing methods.

The technology (e.g., EDA tools, methods, computer circuitry, and systems) described herein can use design modules that have been pre-characterized for relative timing, by applying a characterized relative timing constraints (RTC) to instances used in a system or architecture in such a way that traditional clocked EDA tools can directly support the timing requirements of these RTC design modules. Using this technology, general asynchronous modules can be embedded into a design and can be used to build systems using a standard commercial EDA tool flow. Indeed, this technology enables any relative timing characterized module to be integrated into an architecture or system with similar timing algorithmic support from standard EDA tools for flip-flops and latches.

As previously described, Electronic Design Automation (EDA) for integrated circuit design can be based upon a clocked methodology. Systems using other timing methods may not be directly supported by the EDA tools and flows. Technology enabling the EDA tools to perform automated timing driven design and optimization of integrated circuit systems and architectures using arbitrary timing methodologies is provided. Such systems can be based on timed circuit modules that have been precharacterized for their timing and operational requirements. A method of mapping the precharacterized constraints onto module instances and system netlists can be provided in such a way that the timing driven algorithms in the EDA tools can be enabled to support timing driven design and optimization at all levels of a EDA flow, from a high level synthesis, down to physical design and timing validation. Using the technology described alternative design styles, such as asynchronous design, can directly employ the traditional EDA tools and flows (e.g., clock-based EDA tools and flows).

The following provides a brief overview of the technology previously described. The technology (e.g., EDA tools, methods, computer circuitry, and systems) described herein is based on a theory of relative timing (RT). From a common timing reference, relativistic delays must hold across signal paths or signal frequencies, such that the maximum delay (max-delay) through one path must be less than the minimum delay (min-delay) through another path. In addition, a margin of separation may be required between delays of the two paths. One path, typically the min-delay path, may be a delay based upon a fixed frequency (such as a clock) rather than the delay down a signal path. Relative timing can be therefore represented with the Equation 1.

pod [symbol] poc₀+m [symbol] poc₁ Equation 1

A variable pod can represent a timing reference or event. If pod is an event, a logic path exists between the point of divergence (pod) and both points of convergence (poc₀ and poc₁). If pod is a timing reference, such as a clock, the timing reference can be common to both poc₀ and poc₁. A value m can be a margin or minimum separation between the events, and the value m may be zero or negative. For Equation 1 to hold, the maximum path delay from event pod to event poc₀ plus margin m may be less than the minimum path delay from event pod to event poc₁. In an example, the analogous delay of a frequency based signal, such as a clock, may be substituted for a path delay such that pod can be a rising clock edge and poc₁ can be the subsequent rising edge of the clock.

In another example, a method for characterizing an asynchronous sequential circuit module for inclusion in the commercial EDA tools may have been previously been performed, as described in co-pending U.S. patent application Ser. No. 13/945,775, entitled “RELATIVE TIMING CHARACTERIZATION”, filed Jul. 18, 2013. The characterization circuit can be fully characterized for all timing conditions to hold for the design to operate correctly given the delays and behavior of a desired circuit environment, whether the environment is clocked or asynchronous. The characterization can express delays based on relative timing by creating constraints that are path based or frequency based from pod to poc₀ and poc₁. Performance constraints of a similar form may also be added.

In another example, the pre-characterized modules can include information used to correctly embed characterized modules (e.g., relative timing constraint (RTC) modules) into a system or architecture in such a way that the timing driven algorithms in the EDA tools directly support the correct design, optimization, test and validation of the characterized modules. The full set of constraints from the pre-characterized modules can be represented in a format that is compatible with timing driven algorithms in the EDA tools and the technology described herein. A subset of the constraints can be selected for various steps in the design and validation process. For example, a set of constraints can be selected for synthesis through an EDA tool, such as Design Compiler. In another embodiment, a different set of constraints can be used for timing validation with PrimeTime. The pre-characterization flow may also modify the delay information of cells in the timing characterization file in a liberty format (.Iib) to enable more accurate timing results. The timing constraints can be created in a format that is supported by the various steps in the design flow and by the clocked EDA tools.

In another configuration, a computer-readable medium can be provided comprising computer-readable instructions that, upon execution by a processor, cause the processor to perform the operations of the method of selecting design constraint sets and mapping them onto a system and architecture for the various steps in the design flow, which can be included in a way that directly supports the industry standard EDA CAD flow.

In another embodiment, a system can include a processor and the computer-readable medium can be operably coupled to the processor. The computer-readable medium comprises instructions that, upon execution by the processor, perform the operations of a method of characterizing an asynchronous circuit module suitable for inclusion into the industry standard EDA CAD flow.

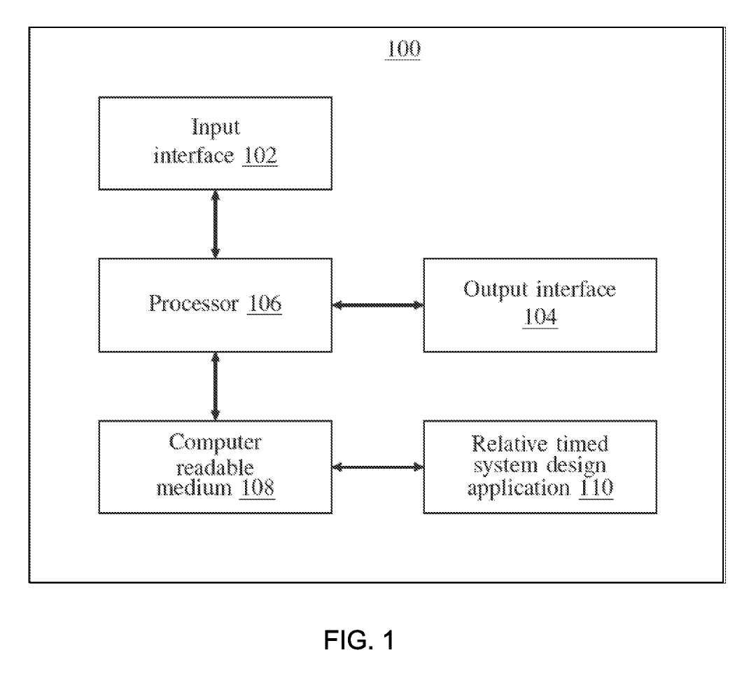

The following provides additional details and examples of the technology previously described. FIG. 1 illustrates a block diagram for a relative timed integrated circuit design system 100. The relative timed integrated circuit design system 100 can include a computing device of any form factor, which may include an output interface 104, an input interface 102, a computer-readable medium 108, a processor 106, and a relative timed system design application 110 that can relate to the relative timed integrated circuit design system 100. Different and additional components may also be incorporated into relative timed integrated circuit design system 100.

The output interface 104 provides an interface for outputting information for review by a user of the relative timed integrated circuit design system 100. For example, the output interface 104 can include an interface to a display, a printer, a speaker, or similar output device. The display can be a thin film transistor display, a light emitting diode display, a liquid crystal display, or any of a variety of different displays. The printer can be any of a variety of printers. The speaker can be any of a variety of speakers. The relative timed integrated circuit design system 100 can have one or more output interfaces that use a same or a different interface technology.

The input interface 102 provides an interface for receiving information from the user for entry into relative timed integrated circuit design system 100. The input interface 102 can use various input technologies including, but not limited to, a keyboard, a pen and touch screen, a mouse, a track ball, a touch screen, a keypad, one or more buttons, or similar input device to allow the user to enter information into the relative timed integrated circuit design system 100 or to make selections presented in a user interface displayed on the output interface 104. The input interface 102 may provide both input and output interfaces. For example, a touch screen both allows user input and presents output to the user.

The computer-readable medium 108 can be an electronic holding place or storage for information so that the information can be accessed by the processor 106. The computer-readable medium 108 can include, but is not limited to, any type of random access memory (RAM), any type of read only memory (ROM), any type of flash memory, or similar medium, such as magnetic storage devices (e.g., hard disk, floppy disk, or magnetic strips), optical disks (e.g., compact disk (CD) or digital versatile disk (DVD) or digital video disk), smart cards, or flash memory devices. The relative timed integrated circuit design system 100 can have one or more computer-readable media that use the same or a different memory media technology. The relative timed integrated circuit design system 100 can also have one or more drives that support the loading of a memory media, such as a CD or DVD.

The processor 106 can execute instructions. The instructions can be carried out by a special purpose computer, logic circuits, or hardware circuits. Thus, the processor 106 can be implemented in hardware, firmware, software, or any combination of these methods. The term “execution” is the process of running an application or the carrying out of the operation called for by an instruction. The instructions can be written using one or more programming language, scripting language, assembly language, or similar language. The processor 106 can execute an instruction, meaning that the processor can perform the operations called for by that instruction. The processor 106 can be operably couple with the output interface 104, the input interface 102, and the with the computer-readable medium 108 (e.g., memory) to receive, to send, to process, and to store information. The processor 106 can retrieve a set of instructions from a permanent memory device and copy the instructions in an executable form to a temporary memory device, such as some form of RAM. The relative timed integrated circuit design system 100 can include a plurality of processors that use the same or a different processing technology.

The relative timed system design application 110 can perform operations associated with designing an integrated circuit that includes relative timed design components. Some or all of the operations described may be embodied in relative timed system design application 110. The operations can be implemented using hardware, firmware, software, or any combination of these mechanisms. In an example, as illustrated by FIG. 1, the relative timed system design application 110 can be implemented in software stored in the computer-readable medium 108 and accessible by the processor 106 for execution of the instructions that embody the operations of the relative timed system design application 110. The relative timed system design application 110 may be written using one or more programming languages, assembly languages, scripting languages, or similar language.

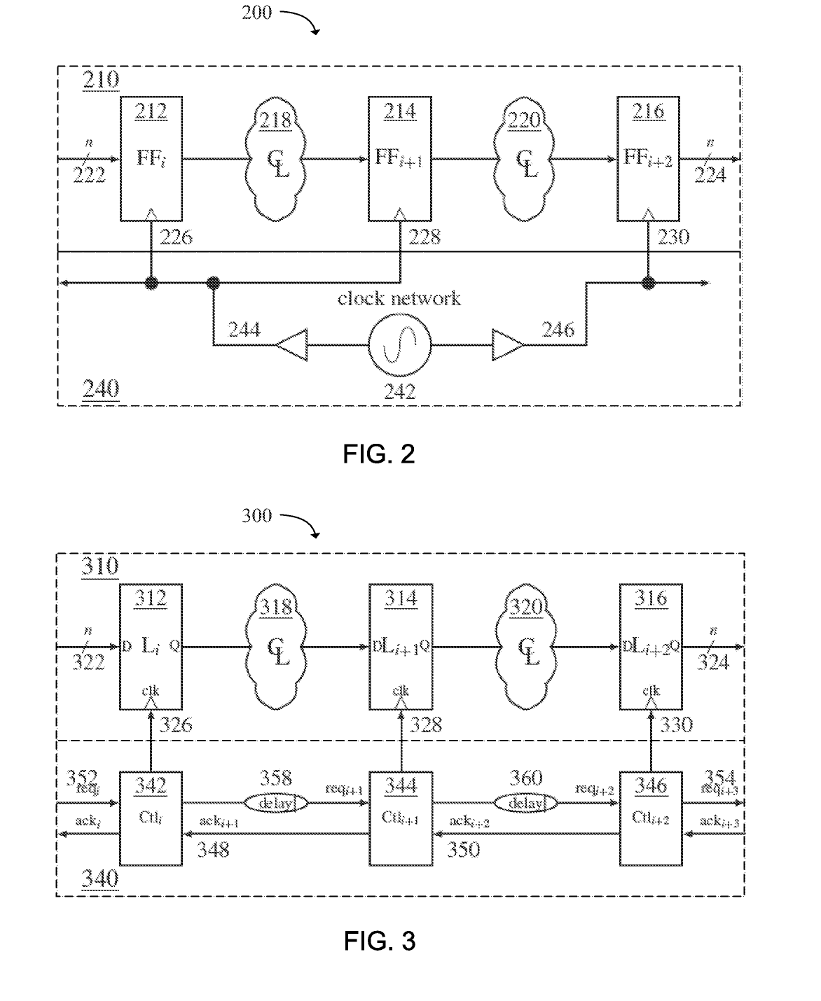

Clocked-based design is directly supported with computer-aided design (CAD) as used by the electronic design automation (EDA) industry. FIG. 2 illustrates an example of a circuit that is supported with clocked-based EDA tools. The circuit can include of a data path 210 and a clock distribution network 240. The data path 210 can include of a first register 212 (e.g., flip-flop), a second register 214, and a third register 216, a first combinational logic (CL) block 218 and a second combinational logic block 220. The first register 212 can accept an input 222 and store the value based on a clock event on signal 226. The third register 216 can output an output 224. The inputs and outputs of the registers and combinational logic blocks can use multiple data lines n (e.g., a bus). The output of the first register 212 can be presented to the input of the first combinational logic 218 and a result can be produced at the output of the first combinational logic 218. When a clock event, such as a rising edge, occurs on a clock input 228 for the second register, the second register 214 can capture the result produced by the first combinational logic 218. Likewise, the output of the second register 214 can be presented to the input of the second combinational logic 220 and a result can be produced at the output of the second combinational logic 220. When a clock event, such as a rising edge, occurs on a clock input 230 for the third register, the third register 216 can capture the result produced by the second combinational logic 220. The clock network 240 can include logic 242 that produces a periodic waveform at a specified frequency. This periodic waveform signal can be distributed across a clock network 244 and 246 to the registers in a design. The traditional EDA tools can support timing driven optimization and synthesis of the combinational logic blocks 218 and 220 based on the target cycle times of the clock generator 242. The clock distribution networks 244 and 246 can maintain the frequency from the clock generator 242 with a low skew between different clock tree paths 244 and 246.

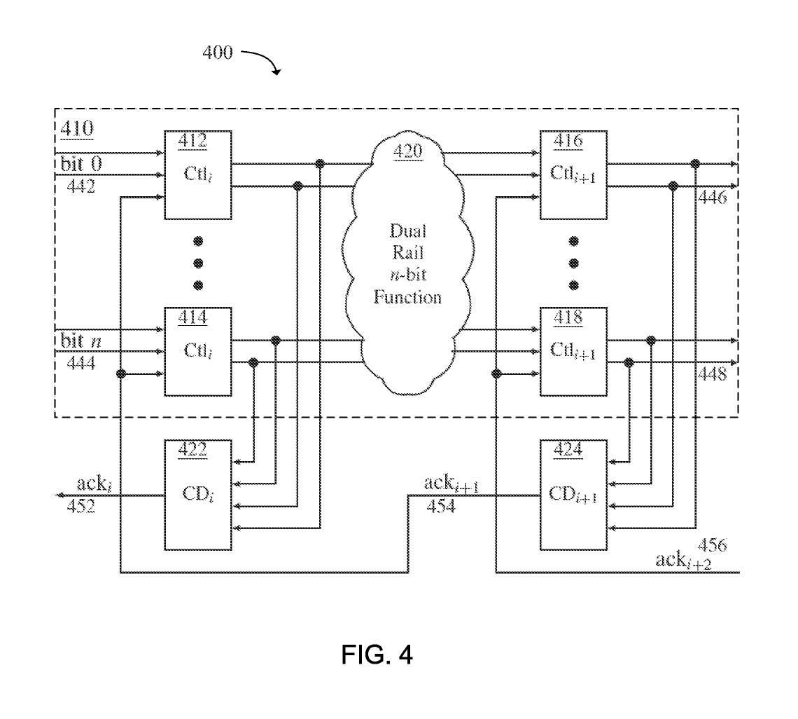

FIG. 3 illustrates an example of an asynchronous circuit 300 of a system with relative timed circuit modules, which may not be supported by traditional clocked-based EDA. In the example of FIG. 3, a separate data path 310 and a control network 340 are used. The data path 310 can include a first register 312 (e.g., latch, such as data or delay flip-flop (D flip-flop) configured with a data input, “D,” and a data output, “Q”), a second register 314, and a third register 316, a first combinational logic block 318 and a second combinational logic block 320. The first register 312 can accept an input 322 and store the value based on a clock event on a first register clock input 326. The third register 316 outputs an output 324. The inputs and outputs of the registers and combinational logic blocks can use multiple data lines n (e.g., a bus). The output of the first register 312 can be presented to the input of the first combinational logic 318 and a result can be produced at the output of the first combinational logic 318. When a clock event, such as a rising edge, occurs on a second register clock input 328, the second register 314 can capture the result produced by the first combinational logic 318. Likewise, the output of the second register 314 can be presented to the input of the second combinational logic 320 and a result can be produced at the output of the second combinational logic 320. When a clock event, such as a rising edge, occurs on a third register clock input 330, the third register 316 can capture the result produced by the second combinational logic 320. The registers 312, 314 and 316 in an asynchronous pipeline can be latches, flip-flops, dynamic gates, or any other memory element.

Rather than use a clock network 240 as shown in FIG. 2 to generate clock events, an asynchronous circuit can use timed circuit modules that employ handshaking protocols to determine when to store data in the registers, as shown in control network 340 of FIG. 3. The asynchronous network shown in FIG. 3 can be similar in structure to the clocked network of FIG. 2. However different structures, such as delay insensitive pipelines or other asynchronous network designs, can be used. This handshaking network can produce the clock signals that control storage of data in the datapath 310. These events can occur with any delay so long as the data at the input of the registers is stable before a clock event occurs. The control network 340 can include a first control module 342, a second control module 344, and a third control module 346. Each data path between latches in the data path can include an associated control channel. An input control channel 352 can be associated with input data 322, a control channel 348 can be associated with a combinational path 318, a control channel 350 can be associated with data logic path 320, and the output 324 can be is associated with control channel 354. Control channels can contain delay logic that is designed to match the delay of signal propagation and data functions of an associated data path. This delay logic includes structures that steer the handshake signals on control channels and create delay, such as delay module 358 and 360. The control channel 348 includes a delay element 350 and the control channel 350 includes a delay element 360. The delay element shown in FIG. 3 is placed on a forward handshake path, but may be placed on the backward path depending on the protocol used. Each of the timed circuit modules 342, 344, and 346 used for the handshake control can implement a function that determines the handshake protocol relationship between the clock signal and the input and output control channels of the modules. Many possible protocols can be used.

FIG. 4 illustrates an example of a delay insensitive asynchronous circuit 400 of another system with timed circuit modules, which may not be supported by traditional clocked EDA. In FIG. 4, the control and data path 410 can be integrated together. Each data bit in the integrated path 410 can be encoded with a communication protocol that identifies data values as well as validity of the data. The integrated path can be encoded as dual-rail, one-of-four, m-of-n codes, delay-insensitive minterm synthesis (DIMS), or any other similar code. The data path 410 can include a first control bank 412 through 414 and a second control bank 416 through 418. The control logic can also include completion detection (CD) logic 422 and 424. The CD logic 422 can assert an acknowledgment (ackᵢ) 452 when all values in the first control bank 412 through 414 are valid, and unassert the ackᵢ 452 when the data values are unasserted. Likewise, the CD logic 422 can assert a subsequent ack (ackᵢ₊₁) 454 when the second control bank 416 through 418 are all valid, and unassert ackᵢ₊₁ 454 when data values are idle. Data can be stored in the control banks according to the protocol implemented. The controllers can implement various protocols with differing amounts of concurrency between the input and output channels. In an exemplary protocol, data can be stored in a control bank when the acknowledgment from the following stage is unasserted and an input is encoded as having valid data. Likewise the output of a control bank can indicate invalid data when data inputs are invalid and the acknowledgment is asserted. Therefore, in this exemplary protocol, the first control bank 412 through 414 can accept inputs 442 through 444. When ackᵢ₊₁ 454 becomes unasserted, the data can be output from the control registers into a dual-rail n-bit function 420 and the completion detection module 422 can assert acknowledgment ackᵢ 452. The output of the first register set 412 through 414 can pass through an encoded function module 420, which can encode a function using dual-rail, m-of-n codes, DIMS, or any other similar code. When the data is encoded as valid to the next control bank 416 through 418 and the input signal 456 is unasserted, the function results can be stored in register bank 416 through 418. The control banks may also perform some of the combinational function logic.

The clocked-based EDA flow may only have integrated timing for a very few sequential cells, such as flip-flops and latches. Therefore, any other module that does not have combinational logic between the flip-flops or latches may be pre-characterized and then passed through the relative timed integrated circuit design system of FIG. 1 in order to receive support of the timing driven algorithms in the EDA tool flow. The application of a relative timed integrated circuit design system for compatibility with the clocked EDA tool flow is not limited to the modules used in the examples illustrated by 300 and 400 of FIGS. 3 and 4, but can be generally extended to any timed design module.

The technology described herein enables the timing driven algorithms that exist in commercial EDA tools to support relative timed modules and relative timed designs in a manner similar to what is natively provided by the tools for the clocked design methodology. Clocked-based EDA design CAD and tool flows can directly support timing driven optimization of the flip-flops 212, 214 and 216 and the latches 312, 314 and 316, as well as combinational blocks 218, 220, 318, 320 and 420. The clock network 240 can also be directly supported by the EDA tools. However, the relative timed modules 342, 344 and 346 in timing control logic 340 may not be supported by the traditional EDA tools. Likewise, in 400 of FIG. 4, the relative timing modules 412, 414, 416, 418, 422 and 424 may not be supported through traditional clocked tool flows. technology described herein can map the timing for modules (i.e., currently unsupported) onto module instances in an integrated circuit design in such a way that the algorithms in the EDA tools can then directly support timing driven optimization of these modules just as the algorithms do for the modules with native support in the EDA tools.

Using this technology, the matching delay elements 358 and 360 and the dual rail n-bit function 420 may take one of two forms: (1) the design modules may be directly synthesized by the EDA tools or (2) the design modules may be combinational logic that is designed by other tools and mechanisms. When synthesized directly by the EDA tool flow, these design modules may require no specific treatment to be supported by the timing driven algorithms in the EDA tool flow. However, the design modules may also be designed and characterized as relative timing modules. With relative timing modules, these modules can become natively unsupported by the EDA tools and may use mechanisms to enable timing driven algorithms in the EDA tools, just as with other natively unsupported modules.

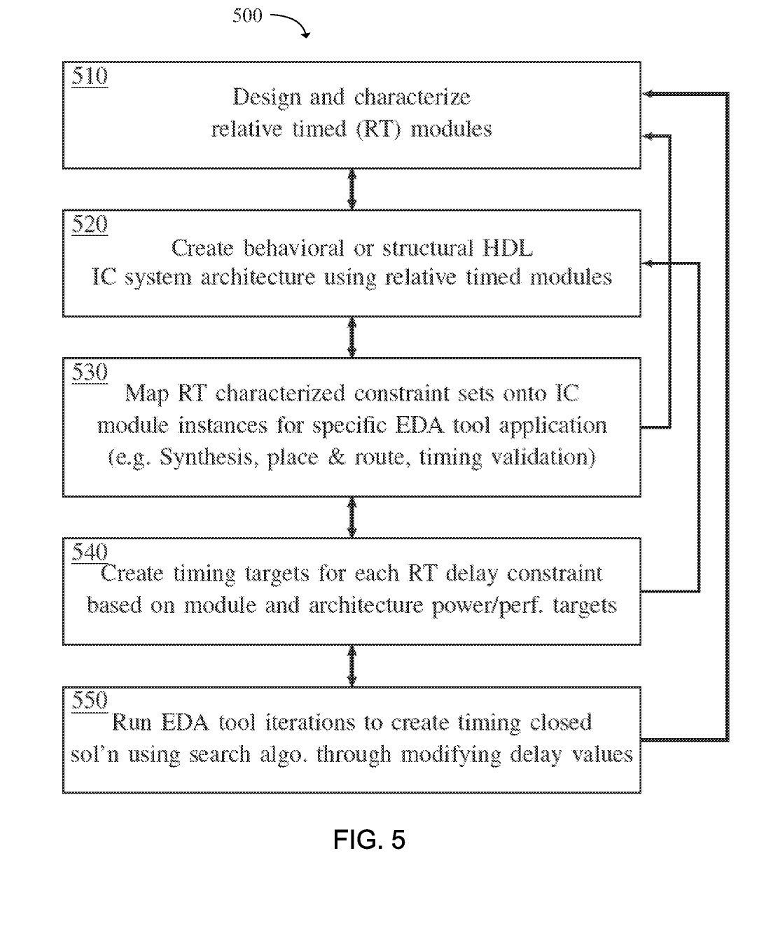

FIG. 5 illustrates a process for the relative timed system design application 110 (FIG. 1). The operations in 500 may be repetitive, and iterations can occur back to earlier operations in the flow chart as indicated by the bidirectional arrows and other flow arrows. Additional, fewer, or different operations may also be performed, depending on the EDA tool or protocol used. The order of the presentation of the operations of FIG. 5 is shown for illustration and is not intended to be limiting. The operations described with reference to FIG. 5 may be implemented by executing the relative timed system design application 110 (FIG. 1).

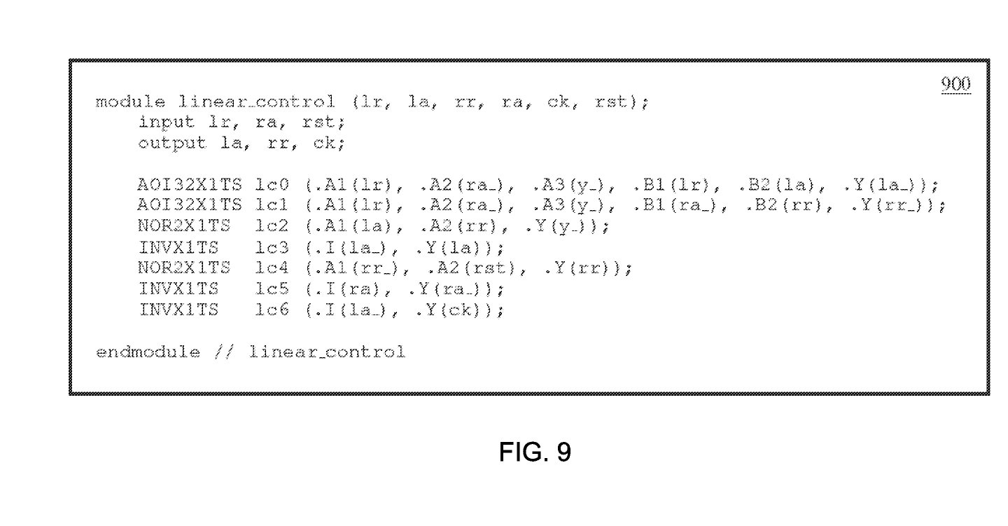

Relative timed (RT) modules can be designed and characterized 510 for relative timing, so the representation of the timing constraints in the design and characterization support timing driven optimization of architectures. Creating behavioral or structural hardware description language (HDL) IC system architecture for an integrated circuit (IC) can be designed using relative time characterized modules (e.g., relative timed modules) 520. In an example, a subset of the design might generate a circuit similar to circuit 300 of FIG. 3. In another example, the design can be encoded in a hardware description language (HDL). For example, the hardware description language may include Verilog, very-high-speed integrated circuits (VHSIC) HDL (VHDL), or any other hardware description language. The design can use any methods that are valid for the hardware description language, including behavioral or structural techniques. However, a subset of the relative timed modules can use structural design descriptions based on instances in the cell library that is used in the design, as illustrated in FIG. 9.

A subset of the constraints provided with the RT design modules 510 can be mapped onto instances of modules for specific EDA tool application 530 in the integrated circuit design 520. These mappings can be made in a way that enable timing driven algorithms in the clocked EDA tools to support timing driven design and optimizations of the RT modules 510, as well as the system 520. This mapping can use any algorithm or method, which may be different for each EDA tool or step in the design process (e.g., synthesis, place and route, or timing validation). The mappings can be in a format that is known by the EDA tools or design steps. For instance, the constraints can be mapped to the Synopsys Design Constraint (.sdc) format, which can be universally understood by most EDA tools.

Timing targets can be created for each RT delay constraint 540. In an example, the RT delay constraint can be based on module and architecture power and performance targets. In another example, the RT delay constraint can be mapped using traditional EDA tools and flows to synthesize and optimize a completed integrated circuit. Any flow, method, or EDA tool may be employed, or additional methods or algorithms may be employed to aid in this process. For instance, in an example, timing closure can be achieved by iteratively running a synthesis tool (e.g., Design Compiler) and changing delay targets of the constraints until no negative timing slacks occur. Negative timing slacks can represent timing violations.

In an example, the full set of constraints provided with the RT design modules 510 can be mapped onto module instances in a completed integrated circuit as a final validation before fabrication. Due to the cyclic nature of some RT design modules and some requirements in the EDA tools that timing graphs be acyclic, a complete mapping may be the result of the union of several independent constraint mappings onto the circuit representation. Any algorithm or method of mapping the design constraints onto the circuit representation and generating correct cyclical timing constraints from acyclic results may be employed.

EDA tools can run iterations to create closed timing solutions using search algorithms through modifying delay values 550. A closed timing solution can be an IC architecture without an timing violations. The iterations can converge the IC architecture or provide closure to the IC architecture for circuit correctness as well as performance conforming to timing constraints.

In an example, the design can be validated using clocked EDA tools to ensure that the design constraints from the characterized RT modules 510 used in the design 520 correctly hold in a final integrated circuit design. For example, post layout extracted parasitics can be used in the validation process. Timing validation tools (e.g., PrimeTime) can be used to validate that the constraints hold.

Various search algorithms can be used to run EDA tool iterations 550. For example, closure algorithms can differ for synthesis, place and route, and timing closure.

For instance, each part of the design can be timing converged based on the relative timing constraints and the associated targets which can be derived from the architectural performance and power goals. In this part of the design, timing values can be modified in an iterative loop to achieve a set of Synopsys Design Constraint (SDC) constraints that the design tools can completely solve. Thus as part of this iteration, one or more commercial EDA tool can be employed to create a design given the constraint set passed. Another tool (e.g., PrimeTime) can be employed to determine if the design has negative slacks. The results can be evaluated, and an algorithm can be used to modify the timing targets of some of the constraints.

Any negative slacks can result in a loss of yield or failure of the design. Therefore, delay targets can be modified in order to achieve convergence. However, modifying timing targets to simplify the convergence for the tools may result in worse performance or power. Thus, the algorithms that are employed can have a direct impact on design quality. Each tool, such as synthesis or place and route tools, have different design goals and generally react differently to changes in the constraint set. Thus, different algorithms can be appropriate for the different tools employed.

Some timing paths can have a larger impact on overall design performance than others. Therefore, paths may be weighted, ordered, or related to other nodes in the closure algorithm in order to optimize the probability of converging with a least loss in performance or power. Algorithms that search and modify alternative paths for sensitive nodes may be used. Algorithms to change the speed at which timing is modified (similar to simulated annealing algorithms) can also be used. The type of node, such as a data path node versus a handshake control path that generates the clock signal, have different properties and may be treated differently in the algorithm. Certain small perturbations in the timing graphs at times can result in large changes to negative slack. For example, a solution with 15 picosecond (ps) worst negative slack may result in modifications that the commercial EDA tools then employs, only to find a solution with 230 ps worst negative slack. Algorithms that compensate for sensitivity of nodes, the types of nodes, the criticality of paths for performance and power, and related paths can result in faster convergence and better power and performance.

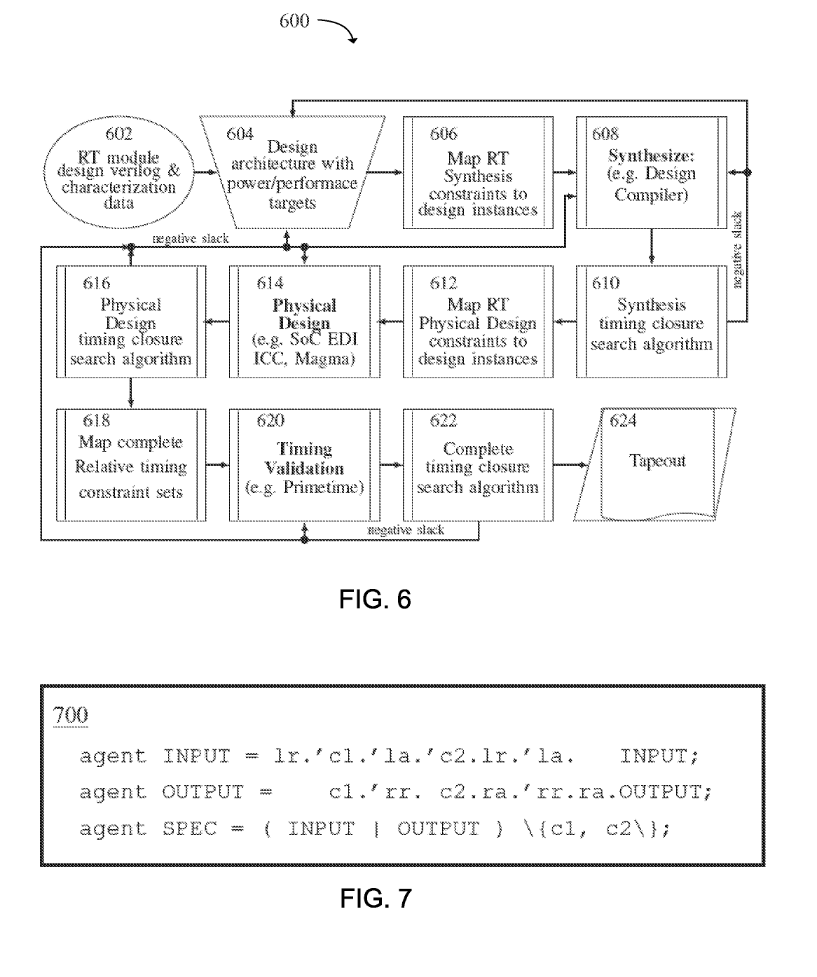

The relative timing constraints can be used to create related timing paths. The related timing paths can create fundamental timing requirements to hold between path constraints, which may not be directly supported by the SDC constraints. Such a relationship can be maintained in the timing closure for various EDA tools 610, 616, and 622, as illustrated in FIG. 6. Timing relationships can be maintained and achieved by adding additional timing information in addition to path delay targets, which includes the relationship between the targets. The additional timing information can be included in a SDC file as a comment, since the additional timing information may not be directly supported by the EDA tool. The comment can be represented with a “pragma”, used in a SDC standard.

For example, assuming a relative time delay represented as a [symbol] b+m [symbol] c (i.e., a variation of Equation 1), and assuming the performance target is 500 ps for the RT constraint with a margin of 50 ps, the following SDC pragmas with associated delays may result:
set_max_delay 0.450—from a—to b
set_min_delay 0.500—from a—to c

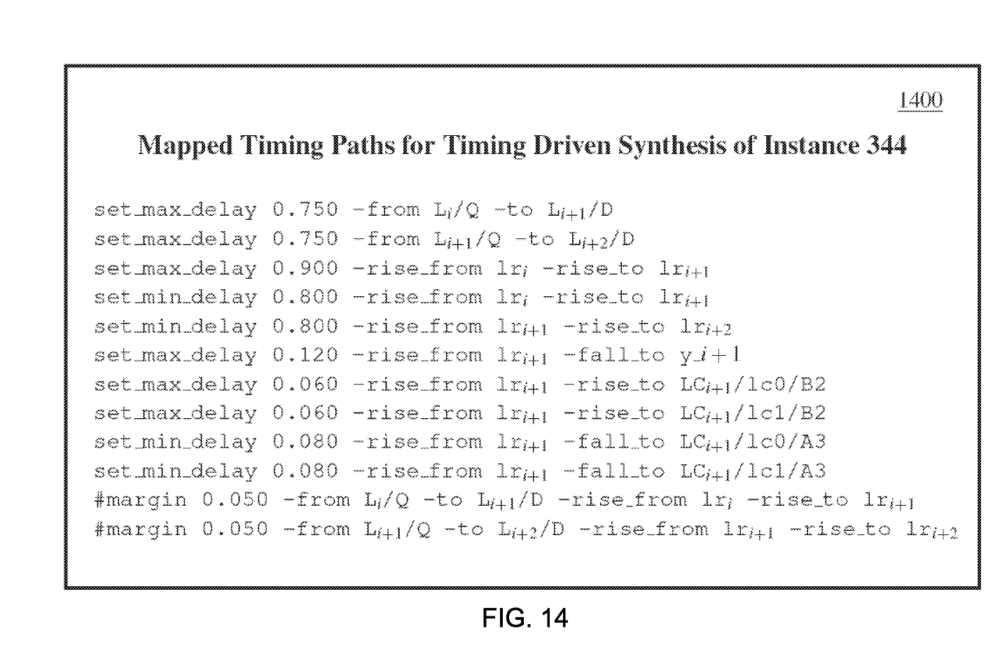

As illustrated by FIG. 14, the relationship between these two constraints (e.g., from a to b, and from a to c) can be specified with a #margin or #dpmargin constraint which ties the two constraints together and includes information regarding the margin of separation, as illustrated by the following:
#margin 0.050—from a—to b—from a—to c

The margin pragma relates the max and min delay paths to ensure that the 50 ps margin holds. The syntax can specified the margin value, followed by the max delay from a to b, followed by the min delay path from a to c. The #dpmargin command can have a similar syntax, except the value of the max delay path can be divided in half before the comparison (i.e., the max delay can be less than 900 ps for the margin to hold).

If negative slack occurs on either of these two paths (max delay or min delay), then timing convergence algorithms can search the design space and modify the timing targets to allow the EDA tools to converge for the complete design. For instance, if the max delay has a negative slack, then an algorithm may increase that delay. For example, assume that the max delay path is increased from 450 ps to 475 ps, then a constraint may not hold, such as 475 ps+50 ps is not less than 500 ps. Thus, the min delay path can also be increased by 25 ps for the relationship to hold.

In another example, min delay constraints may have no upper delay bounds. Thus, a delay of 800 ps from path a to c can conform to the min delay path. However, if the min delay path is a performance sensitive path, an associated max delay constraint can also be included, which may result in the following constraint set if the performance target is 500 ps:
set_max_delay 0.400—from a—to b
set_max_delay 0.500—from a—to c
set_min_delay 0.450—from a—to c
#margin 0.050—from a—to b—from a—to c

The constraint set can ensure that the longest delay path is actually less than 500 ps. The constraint set can bound the path from a to c to be less than or equal to 500 ps and greater than or equal to 450 ps. If a min delay path has a negative margin with such a constraint, increasing the max delay path may result in a solution that converges. Likewise, reducing a min-delay value where possible can also result in convergence.

Some tools may have different constraints which modify the algorithms and approach for timing closure. For instance, for physical design, Synopsys' ICC supports a full SDC specification. However, Cadence's SoC Encounter EDI may not support the SDC constraint set_size_only. Thus with SoC Encounter EDI, circuits in the characterized modules may be specified as set_dont_touch to apply relative timing constraints. When using SoC for physical design, if timing closure is not achieved, a user can iterate back to the synthesis tool to size the gates that are identified as set_dont_touch.

An algorithm that can be used for optimization can use different timing targets for the physical design relative to the timing target of the synthesis tool. For example, if a negative slack exists on a min-delay path in physical design, a user (or automation) can increase the min-delay path value in synthesis in order to slow down the path when the paths gets placed and routed, but not change the timing target for the physical design tool.

Another difference between tool sets can exist between synthesis, physical design, and timing validation. The synthesis and physical design constraint sets can be incomplete, but can consist of a subset of constraints, which can allow the tools to converge on a good solution. Likewise, the constraints for synthesis and physical design may only include speed independent constraints, which do not take into account arbitrary wire delays. For timing validation the full set of timing constraints can be checked. Timing validation can include all delay insensitive checks that allow arbitrary delay across wire segments. Another difference in timing validation is that the possibility of modifying the timing locally may not result in convergence. Another constraint may be added to the constraint set, and the design may return back to design, synthesis, or physical design tools with an extra constraint to ensure that the final solution is robust and all timing holds.

FIG. 6 illustrates a flow chart of an exemplary relative timed system design application 110 (FIG. 1). FIG. 6 illustrates an EDA flow that supports timing driven optimization and validation of an integrated circuit with timed modules, including traditional EDA tools used by the industry and additional operations to constrain the clocked EDA tools. Additional, fewer, or different operations may be performed based on the EDA system configuration. The order operations of the flow chart of FIG. 6 are not intended to be limiting. The operations described with reference to FIG. 6 may be implemented by executing relative timed system design application 110 (FIG. 1).

Relative timing design modules can be expressed in a hardware description language (e.g., Verilog) and their characterization data and information 602 can be provided. Additional information, such as cell library information or architectural performance targets, can also be provided. A complete architecture or system can be designed with power and performance targets 604. The design can include instances of relative timed design modules. The architecture can be expressed behaviorally in a hardware description language, such as Verilog.

Each instance in the design that has been characterized for relative timing can have the constraints mapped to the specific design instances 606 for synthesis. The specific design instances for synthesis can include all constraints necessary to enable the timing driven algorithms in the EDA tools for design optimization. In an example, the mapping of relative timed constraints can include commands that do not allow modification of the logic of the RT characterized modules, commands to cut timing cycles in the modules, or commands that define timing paths related to the module. Additional, fewer, or different operations may be performed depending on the EDA system configuration. Any method of mapping the timing constraints onto an architecture may be employed. The mapping of relative timed constraints to design instance 606 can enable timing driven optimizations of relative timed design modules. Timing cycles can be formed due to architectural cycles, which can be cut to create a directed acyclic timing graph (DAG). The clocked-based tools can automatically perform cycle cutting, but the clocked-based tools may not inherently preserve the timing paths, including timing paths specified by the relative timed constraints. Architectural cycle cutting can remove timing cycles in the architecture and also preserve the timing paths required for timing driven optimization. Architectural cycle cutting can be used to support relative timing modules using clocked-based EDA tool flows. The design can be synthesized 608 from the behavioral hardware description language. Synthesis can employ a traditional clocked-based EDA tool, such as Design Compiler.

In an example, a determination of a test methodology to employ can be made. If testing is not employed, then the process can continue to a synthesis timing closure search algorithm 610. Manufacturing testability can be added to the design. For example, a scan test can be selected, and synchronous EDA tools (e.g., Tetramax or FastScan) may be employed to create scan chains and test vectors. Some additional relative timing characterized modules may be employed to support the testing style selected.

As previously described relative to search and closure algorithms, a synthesis timing closure search algorithm 610 can perform timing closure for the relative timed modules that are included in the integrated circuit architecture. Timing closure can be achieved when no timing violations occur in the system based on both clocked and relative timing delay paths. Iterations of steps 604-610 can be applied to remove the negative slack or timing errors. The circuit design can be synthesized and timing errors, represented as negative slack, can be determined. Delay targets and margins can be modified to remove the negative slack. The circuit design can then be re-synthesized and timing targets modified until no timing violations occur in the circuit design. The synthesis timing closure may also result in modifications to the architecture or to relative timed design modules. The synthesis timing closure can allow for iterations in the traditional clocked-based EDA tool flow.

In another example, a pre-layout design can be validated for correctness. The correctness validation can be performed using traditional clocked-based EDA tools, such as ModelSim, NCVerilog, or Eldo.

Additional methods or algorithms can be applied to the circuit architecture to help optimize the design for power and performance. For example, the relative timed architecture can be an asynchronous design, which can contain various cycles and local frequencies, which can make architectural optimization different than with traditional clocked design. Any method can be applied to optimize the architecture for power and performance. The power and performance optimization can be performed by a system power and performance optimizer and include methods, such as timed separation of events, canopy graphs, visualization techniques, voltage reduction, or power gating. The power and performance optimization can include additional methods and algorithms that are not used in clocked performance optimization, which may include iterations using CAD components of the clocked EDA tool flow.

Each instance in the design that has been characterized for relative timing can have constraints mapped to specific design instances for physical layout 612. The specific design instances for physical layout can include all constraints necessary to enable the timing driven algorithms in the EDA tools for design optimization. For example, the specific design instances for physical layout can include commands that do not allow modification of the logic of the RT characterized modules, commands to cut timing cycles in the modules, or commands that define timing paths related to the module. The specific design instances for physical layout can also include commands to cluster related nodes together or to use force directed methods based on timing constraints to optimize the power and performance of a design based on placement of the cells in a design. Any method of mapping the timing constraints onto an architecture may be employed. The mapping of specific design instances for physical layout can enable timing driven optimizations of relative timed design modules.

Next, the physical design can be created 614. The physical design can be performed with any of the traditional EDA design tools and CAD tools, such as Magma, ICC, or SoC. With physical design, the design of the integrated circuit may be completed. Similar to synthesis timing closure, a physical design timing closure search algorithm 616 can be used to remove negative slack and provide timing closure of the physical design. Timing closure can be achieved when no timing violations occur in the system based on both clocked and relative timing delay paths. Iterations of steps 604-616 can be applied to remove the negative slack or timing errors.

Complete relative timing constraint sets can be mapped to physical design instances 618 for timing validation of behavioral and timing correctness. In an example, only a subset of speed-independent timing constraints may be employed in the design flow for synthesis and physical design. For a final design validation a complete robust set of constraints may be employed. Mapping for timing validation can include not only a full set of speed-independent constraints, but also the additional constraints that are used when modeling the system using delay-insensitive (untimed) methods. For example, multiple sets of constraints can be created that can validate possible timing requirements for the design to operate correctly at a desired performance. Timing validation can use iterative validation runs using different constraint sets whose union covers all of the constraints. The iterations can be due to the normally sequential and cyclic nature of relative timed design modules coupled with (a) a need to cut timing cycles to form timing graphs that are directed acyclic graphs (DAG), and (b) a desire to preserve the timing paths that must be checked. These two conditions can often mutually exclusive for different timing constraint paths, requiring multiple validation runs. Any method of mapping the full set of timing constraints onto an architecture and multiple run sets may be employed. The mapping for timing validation can enable timing driven optimizations of relative timed design modules. The post-layout design can be validated 620 for performance, correctness and yield. Clocked-based timing validation EDA tools can include PrimeTime and ModelSim. Similar to synthesis timing closure and physical design timing closure, a complete timing closure search algorithm can be used to remove negative slack and provide timing closure of the complete post-layout design. Timing closure can be achieved when no timing violations occur in the system based on both clocked and relative timing delay paths. Iterations of steps 604-622 can be applied to remove the negative slack or timing errors. After the negative slack is removed, the final validated integrated circuit can be taped out 624 and sent to a foundry for manufacture.

In an example, the linear pipeline stage 300 (FIG. 3) can be part of a relative timed architecture 520 (FIG. 5). This pipeline can implement any function, such as a pipelined multiplication operation. For example, FIG. 7 illustrates a formal specification of the behavior for the control modules 342, 344, and 346 using a Calculus of Communicating Systems (CCS).

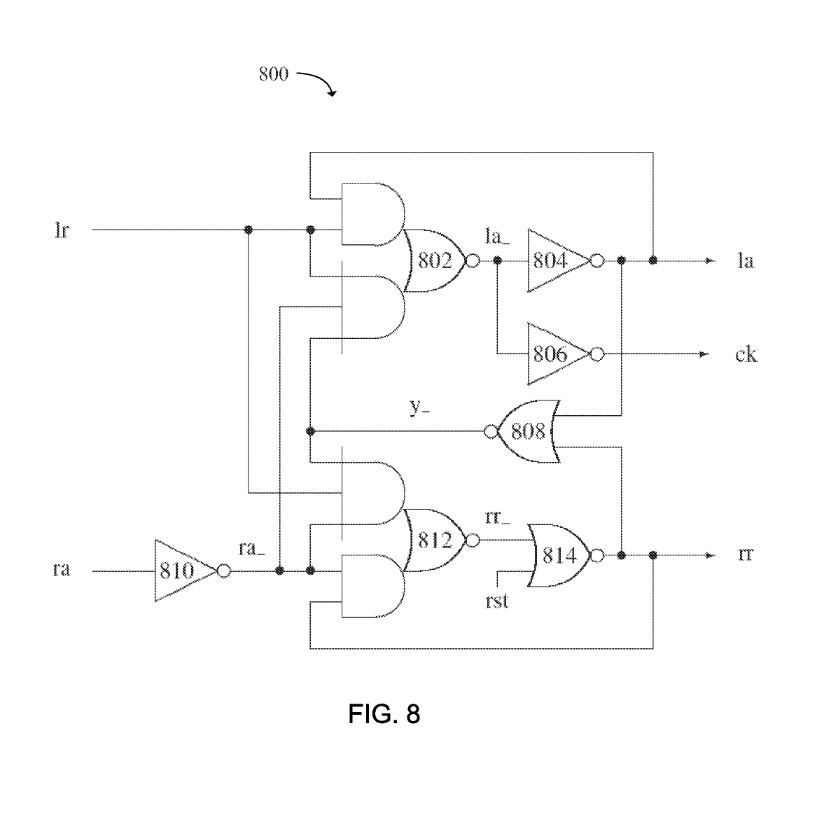

Many different methods and circuit styles for implementing control modules can be used, such as state graphs and symbolic transition graphs (STG). In an example, the circuit implementation 800 of the specification 700 is illustrated in FIG. 8. The control module circuit (i.e., handshake circuit) includes of seven combinational logic gates: Static logic gates, such as inverters 804, 806, and 810 and NOR gates 808 and 814, and complex gates, such as AND-OR-invert gates (AOI gates) 802 and 812. AOI gates are two-level compound or complex logic functions constructed from the combination of one or more AND gates followed by a NOR gate. Any other type of gate may also be used such as dynamic logic, domino gates, latches, or majority gates. The logic of module 800 can implement a sequential function. Sequential logic can be implemented with feedback, as shown. Feedback can create cycles in the topology of the circuit, as is the case with the cycles through gates 802 and 804; gates 802, 804, and 808; gates 812 and 814; and gates 812, 814, and 808. Sequential circuits can also contain state that exists by using latches, dynamic gates, or majority gates. A circuit can be described using a hardware description language, such as Verilog. In an example, the logic represented by 800 can be mapped to a 130 nanometer (nm) Artisan cell library 900 with structural Verilog, as illustrated in FIG. 9. Then, the circuit design can be characterized according to the operation 510 (FIG. 5).

Relative timing is a mathematical timing model that enables accurate capture, modeling, and validation of heterogeneous timing requirements general circuits and systems. Timing constraints can be made explicit in these designs, rather than using traditional implicit representations, such as a clock frequency, to allow designers and tools to specify and understand the implications and to manipulate the timing of more general circuit structures and advanced clocking techniques. Timing constraints that affect the performance and correctness of a circuit can be transformed into logical constraints rather than customary real-valued variables or delay ranges. Logical constraints can support a compact representation and allow more efficient search and verification algorithms to be developed, which can greatly enhance the ability to combine timing with optimization, physical placement, and validation design tools. As a result, the way in which timing is represented by designers and CAD tools can be altered in a way that still allows the EDA tools to perform timing driven optimization, but also gives fine-grain control over the delay targets in a system. This approach of using explicit timing constraints can provide significant power-performance advantages in some circuit designs.

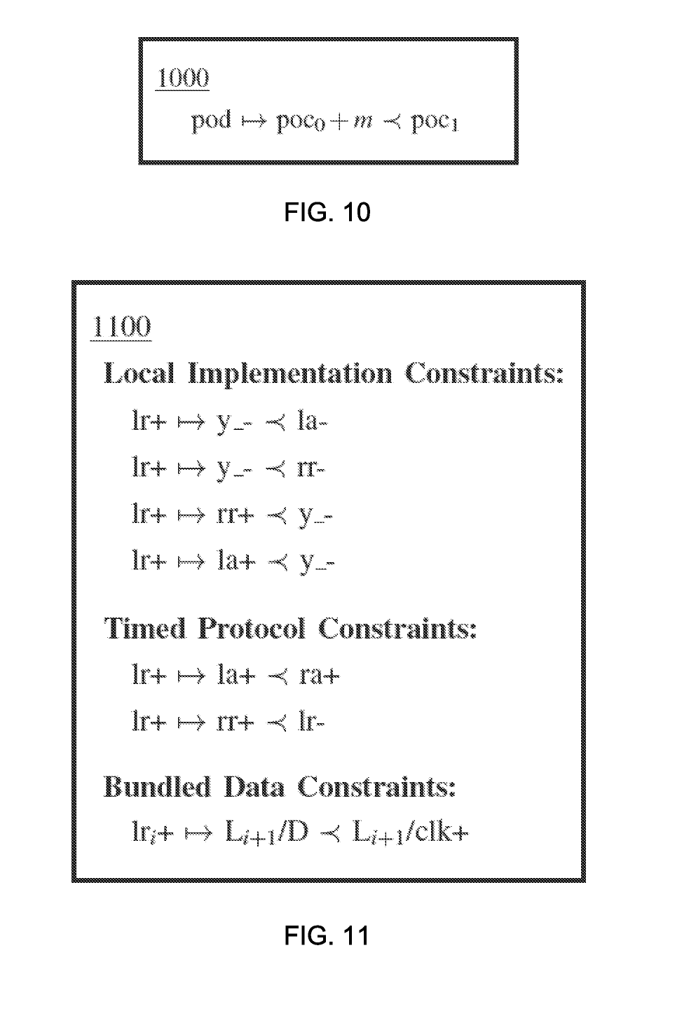

Timing in a circuit can determine both performance and correctness. Relative timing can be employed to represent both correctness and performance conditions of control modules. For example, the timing constraints can be represented as logical expressions that make certain states unreachable. The states that are removed can contain circuit failures, thus timing can be necessary for circuit correctness. Thus, if the all timing is met in a physical realization, the circuit can operate without failure. The performance constraints may not be critical for correct circuit operation, but rather performance constraints can ensure performance targets are met. FIG. 10 illustrates a general form for path based relative timing employed for specifying relative timing constraints 1000 (also represented in Equation 1). Equation includes a point-of-divergence (pod) and a point-of-convergence (poc). The point of divergence pod may be any event that creates other events in a system, such as a clock event or a handshake signal. The point of convergence consists of two events poc₀ and poc₁, and margin m. The two poc events are ordered in time for the circuit to operate correctly, or to achieve a desired performance. The maximum delay between event pod and event poc₀ plus margin m can be less than the minimum delay from event pod to event poc₁.

FIG. 11 illustrates the speed-independent timing constraints 1100 for the circuit of FIG. 9 to operate correctly in a system. The constraints 1100 can include three classes: Local implementation constraints, timed protocol constraints, and bundled data constraints. The set of delay-insensitive constraints (not shown) can be part of a full design characterization flow. The number and type of constraints can be determined based on the gates used for the implementation, the concurrency of the protocol, and the system design. In the exemplary embodiment of the constraints in FIG. 11, if no index to the pod, poc₀, and poc₁ exist, the events can reference nodes local to the module. When indices do exist, such as for the Bundled Data Constraints, the indices can indicate references to nodes in different module instances or in a higher level of hierarchy in the design. Larger indices (i.e., higher number indices) can indicate references down the pipeline (i.e., downstream) reached through request signals in the design, whereas smaller indices (i.e., lower number indices) can pass up through the pipeline (i.e., upstream) via acknowledge signals. Thus, the path for the bundled data constraint can move to the downstream controller through a request signal to a downstream controller's latch. The timing constraints 1100 of FIG. 11 provides an example and is not intended to be limiting. Additional, fewer or different methods of representing the endpoints in a relative timed equation may also be used.

Constraints can be mapped 530 (FIG. 5) onto design instances. For example, the paths and delay constraints for the RT constraint Ir+ [symbol] y_− [symbol] Ia− in FIG. 11 can be the following when applied to instance 344 in FIG. 3: The maximum delay of path Irᵢ₊₁+→Ia_{—i+1}−→Iaᵢ₊₁+→y_{—i+1}− can be less than the minimum delay of path Irᵢ₊₁+→Ia_{—i+1}−→Iaᵢ₊₁+→raᵢ+→ra_{—i}−→rr_{—i}+→rrᵢ−→Irᵢ₊₁−→Ia_{—i+1}+→Iaᵢ₊₁−. The signal label (e.g., Ia) followed by an underbar (_) can represent an enable low signal (e.g., Ia_), while the signal label without a subscript can represent an enable high signal (e.g., Ia). The minus sign (−) following the signal label can represent a falling edge of the signal (e.g., Ia−), while the plus sign (+) following the signal label can represent a rising edge of the signal (e.g., Ia+). The integer i can represent an upstream design instance, while the integer i+1 can represent the local design instance. Several notable aspects of this path exist. The first three transitions of the two paths are identical, therefore a common path algorithm in the clocked-based EDA tools can be employed, such as “common path pessimism”. As illustrated, the pod to poc₁ path can be cyclic. Thus, this cyclic path can be broken somewhere to ensure that the timing graphs are acyclic. Various methods can be employed for synthesis and validation of this cyclic path, including setting targets that are subsets of the path, or having the sum of path segments meet a relative timing constraint inequality. Any method that correctly maps paths onto the timing tools in a way that is supported by the clocked-based EDA tools may be employed. In an example, cycle cutting can be employed to both create a directed acyclic timing graph as well as ensure that the timing paths pass through the desired gates in the RT characterized design modules.

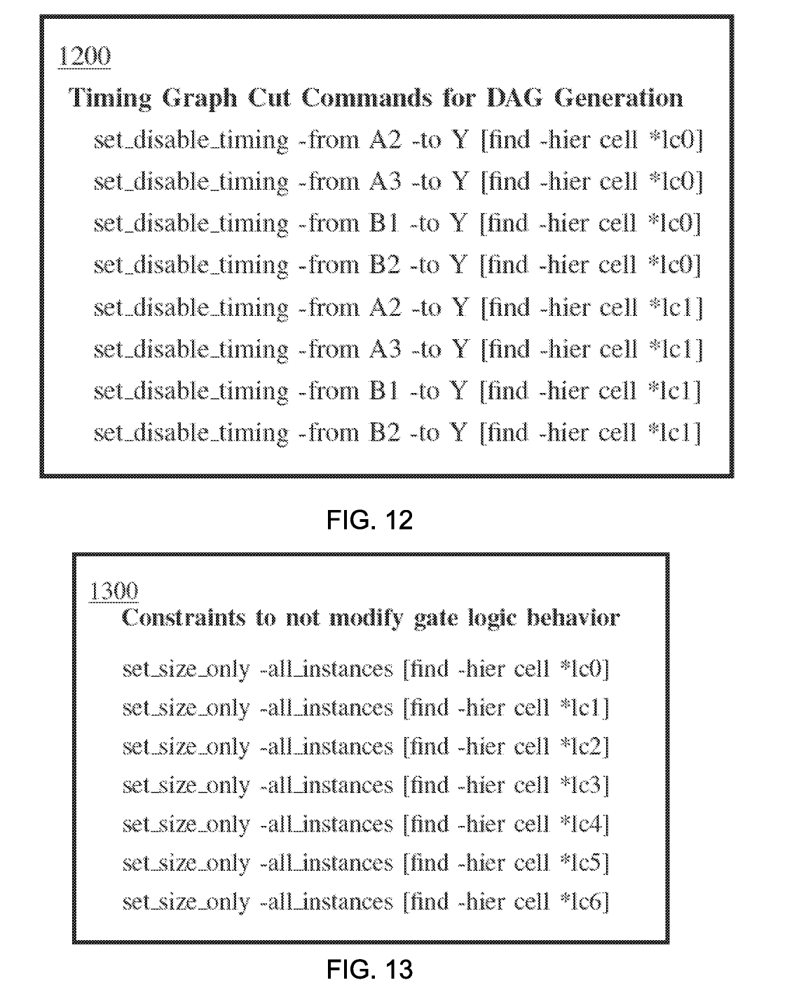

A set of exemplary constraints 1200 that break the structural timing cycles of the module 900 in FIG. 9 are shown in FIG. 12. The set of constraints 1200 can be used to create a timing graph across all nodes in the design as a directed acyclic graph (DAG). The timing graph can cut commands 1200 can use the standard “set_dont_touch” command to break timing paths from some of the input pins to the output pins in the gates of a module. These cuts 1200 can refer to the exemplary circuit 800 of FIG. 8 and its exemplary hardware description language representation 900 in FIG. 9. In this example, cutting timing paths in two gates 802 and 812 can be sufficient to cut both local cycles and architectural cycles produced from the handshake circuits. The feedback cycles created from signal Ia, rr and y_ can be cut through gates 802 and 812. Additionally, the architectural feedback cycles produced from the handshake signals can also be cut by disabling the ra_ pins in these gates. The cuts can be made such that at least one timing path may remain for every gate. Creating at least one timing path for every gate allows each gate to be properly optimized using the timing driven algorithms in the EDA tools, so long as a timing arc (as illustrated in FIG. 14) passes through each gate. Different methods of cutting timing cycles to create a directed acyclic timing graph may be used. Additional, fewer, or different path cuts may be used to create the directed acyclic graph.

FIG. 13 illustrates a set of exemplary constraints 1300 provided to ensure that the design modules characterized for relative timing are not logically modified by the clocked EDA tools. Many unsupported modules that are characterized for timing to be included in the EDA tool flow can have feedbacks and may have redundant covers to avoid hazards or glitches that would otherwise occur under various modes of operation. The clocked-based EDA tools can optimize out redundant covers. Local modifications to a module can also invalidate the characterization results of the module. Thus, most cells in a relative time characterized module can be protected from logical modification in the synthesis flow. For example, a set of commands 1300 shown in FIG. 13 can apply to the relative timed design module 900 of FIG. 9. In FIG. 13, the set_size_only commands are used. The set_size_only command can allow gate instances to be resized to different drive strengths to optimize the gate instances for power and performance, but may not allow the gate instances to be logically modified. Other commands, such as set_dont_touch, can also be used. The set_dont_touch command does not allow the logic nor the drive strength to be modified by the EDA tools. Different methods of logically protecting gates while allowing some modifications may be applied. Additional, fewer, or different constraint sets may be used to allow flexibility in the tool flows yet retain the essential properties of relative timing. For instance, inverters on the primary inputs and outputs may not need to be protected with constraints.

FIG. 14 illustrates a set of timing paths 1400 created in RT constraint mapping 530 (FIG. 5) for the synthesis and design of relative timed instance 344 (FIG. 3). The set of timing paths 1400 assumes the relative timing constraint set 1100 is employed on the the directed acyclic timing graph generated from the timing graph cut commands 1200. The timing paths in 1400 can be mapped onto instances, as used in the exemplary architecture 300. For example, the timing paths 1400 assumes the combinational data paths 318 and 320 require a logic delay of 0.750 ns, as specified by the first two constraints. The first and third constraints of 1400 cover the “Bundled Data Constraints” of 1100 providing a 50 ps margin. All other paths in 1100 can also be covered in the timing paths 1400.

In another example, the path for a first “Local Implementation Constraints” indicates that the maximum delay from Ir+ [symbol] y_− is less than the minimum delay from Ir+ [symbol] Ia−. The full maximum delay path can be constrained to be less than 0.120 ns by a fifth constraint in 1400. The minimum delay path Ir+ [symbol] Ia− mapped onto an instance (as shown earlier) can be Irᵢ₊₁+→Ia_{—i+1}−→Iaᵢ₊₁+→raᵢ+→ra_{—i}−→rr_{—i}+→rrᵢ−→Irᵢ₊₁−→Ia_{—i+1}+→Iaᵢ₊₁−. A subset of this path can be emulated from the third constraint in 1400. The constraint can starts from Ir rather than rr but can pass through the same gates. The path can also be a subset of the full path. Since this path subset has a minimum delay of 0.800 ns, which is substantially more than a delay of 0.120 for the full path of the maximum delay component of the relative timing constraint, the circuit can be correctly synthesized to meet that timing constraint.

In an example, paths and subsets of paths from timing constraints 1100 can be mapped onto each of the timing constraints in the timing paths 1400. When this mapping is employed for all relative timing instances in a design, a set of constraints can be passed to the clocked-based EDA tools that can ensure the design is timing optimized for power and performance while meeting the timing constraints in the system. Additional, fewer, or different constraints may be employed. Different methods and algorithms for generating the constraint sets may be employed. In an example, the delay elements 358 and 360 of FIG. 3 can be automatically generated by the synthesis tools.

The creation of a similar but different subset of constraints, as shown in FIGS. 12, 13, and 14, may be employed for each step and CAD tool in a design flow. Additional, fewer, or different constraints may be used. Also, additional, fewer or different steps may be employed in the design flow that are not part of the traditional EDA tool flow. For instance, in the example flow 600 of a relative timed system design application, synthesis timing closure 610 may be used to create delay targets used in the timing paths 1400. The synthesis timing closure 610 may use an iterative process using the synthesis tools, such as Design Compiler. In an example, a subset or an approximation of the actual paths in a design may be sufficient for many steps in the design flow, as was the case of the constraints in the timing paths 1400. However, a final set of constraints may be more rigorous and complete where complete timing validation tools validate actual delays and variations that may exist in the physical design including wire fork delays. Therefore, timing validation can employ relative timing constraints created from delay-insensitive delay models rather than speed-independent models that are usually sufficient for the design process.

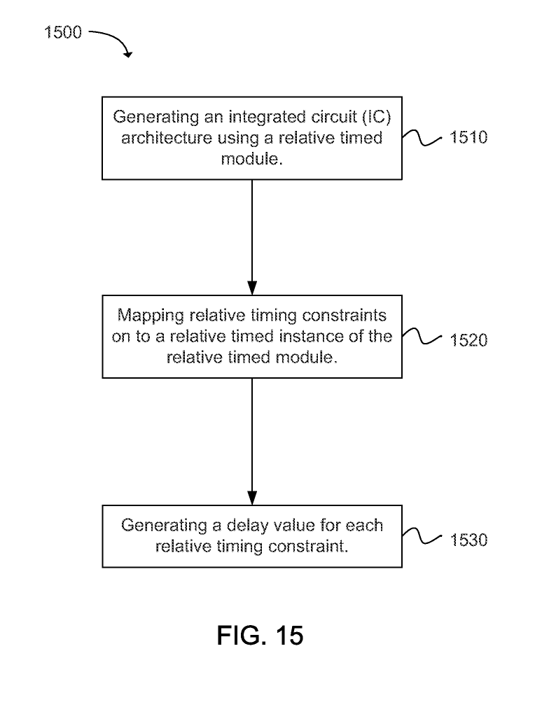

Another example provides a method 1500 for generating a relative timing architecture enabling use of clocked electronic design automation (EDA) tool flows, as shown in the flow chart in FIG. 15. The method may be executed as instructions on a machine or computer circuitry, where the instructions are included on at least one computer readable medium or one non-transitory machine readable storage medium. The method includes the operation of generating an integrated circuit (IC) architecture using a relative timed module, as in block 1510. The operation of mapping relative timing constraints (RTC) on to a relative timed instance of the relative timed module follows, as in block 1520. The next operation of the method can be generating a delay value for each relative timing constraint, as in block 1530.

In an example, the operation of generating the delay value can further include iteratively modifying the delay values of the relative timing constraints until no timing violations occur in the IC architecture thereby generating a closed timing solution. In another example, the method can further include optimizing power and performance of the IC architecture using timing driven optimizations of the relative timed module within clocked tool flows. Optimizing power and performance can include timed separation of events, canopy graphs, visualization techniques, voltage reduction, or power gating.

In another configuration, the relative timing constraint (RTC) can be represented by pod [symbol] poc₀+m [symbol] poc₁, where pod is the point of divergence (pod) event, poc₀ is a first point of convergence (poc) event to occur before a second poc event poc₁ for proper circuit operation, and margin m is a minimum separation between the poc₀ and the poc₁. The delay values can provide a maximum target delay for a first relative event path between the pod event and the first poc event, a minimum target delay for a second relative event path between the pod event and the second poc event, and a margin target delay representing a minimum separation between the first relative event and the second relative event.

In another example, the operations of mapping relative timing constraints and generating the delay value for each relative timing constraint can further include defining endpoints for the relative timing constraint, and determining a timing path between endpoints of the relative timing constraint, where each gate of the IC architecture can be represented in at least one timing path of the IC architecture.

In another configuration, the method can further include preventing logic modification of the relative timed module or relative timed instance.

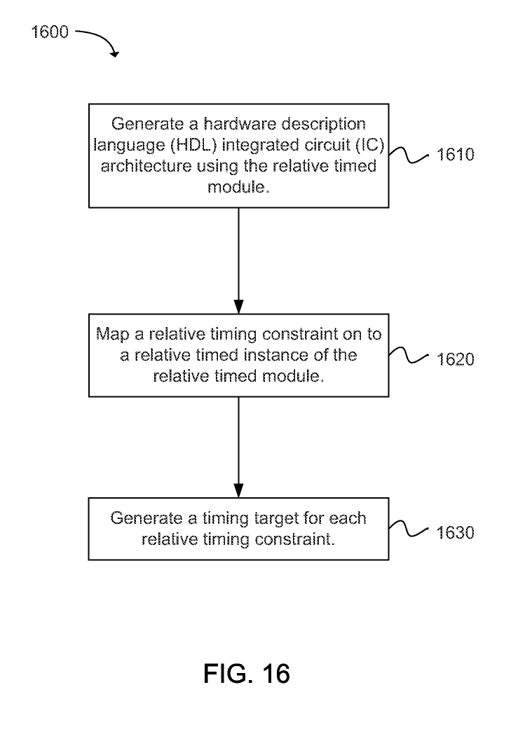

Another example provides functionality 1600 of computer circuitry of an electronic design automation (EDA) tool for clocked tool flows configured for generating a relative timing architecture using a relative timed module, as shown in the flow chart in FIG. 16. The functionality may be implemented as a method or the functionality may be executed as instructions on a machine, where the instructions are included on at least one computer readable medium or one non-transitory machine readable storage medium. The computer circuitry can be configured to generate a hardware description language (HDL) integrated circuit (IC) architecture using the relative timed module, as in block 1610. The computer circuitry can be further configured to map a relative timing constraint (RTC) on to a relative timed instance of the relative timed module, as in block 1620. The computer circuitry can also be configured to generate a timing target for each relative timing constraint, as in block 1630.

In an example, the computer circuitry can be further configured to iteratively modify the timing targets of the relative timing constraints until no negative timing slacks occur in the HDL IC architecture. The negative timing slacks can represent timing violations. In a configuration, the computer circuitry configured to iteratively modify the timing targets can be further configured to converge negative timing slacks for both clocked timing delay paths and relative timing delay paths. In another configuration, the computer circuitry configured to iteratively modify the timing targets can be further configured to add delay elements into the HDL IC architecture to satisfy the relative timing constraint. In another configuration, the computer circuitry configured to optimize power and performance of the HDL IC architecture using timing driven optimizations of the relative timed module within the clocked tool flows.

In another example, the computer circuitry configured to map the relative timing constraint can be further configured to define endpoints for the relative timing constraint. The computer circuitry configured to generate the timing target can be further configured to determine a timing arc between endpoints across a timing path of the relative timing constraint, where one of a composite of the timing arcs pass through each gate of the IC architecture.

In another configuration, the relative timing constraint (RTC) can be represented by pod [symbol] poc₀+m [symbol] poc₁, where pod is the point of divergence (pod) event, poc₀ is a first point of convergence (poc) event to occur before a second poc event poc₁ for proper circuit operation, and margin m is a minimum separation between the poc₀ and the poc₁. The timing targets can provide a maximum target delay for a first relative event path between the pod event and the first poc event, a minimum target delay for a second relative event path between the pod event and the second poc event, or a margin target delay representing a minimum separation between the first relative event and the second relative event.

In another example, the computer circuitry can be further configured to design and characterize the relative timed module. In another configuration, the computer circuitry configured to generate the timing target for each relative timing constraint can be based on an architecture power target or an architecture performance target.

In another example, the EDA tool can be a synthesize tool, an optimization tool, a physical design tool, a physical route and placement tool, or a timing validation tool. In another configuration, the relative timed module can generate a behavioral HDL IC architecture or structural HDL IC architecture by encoding the design into Verilog, HDL, or very-high-speed integrated circuits (VHSIC) HDL (VHDL).

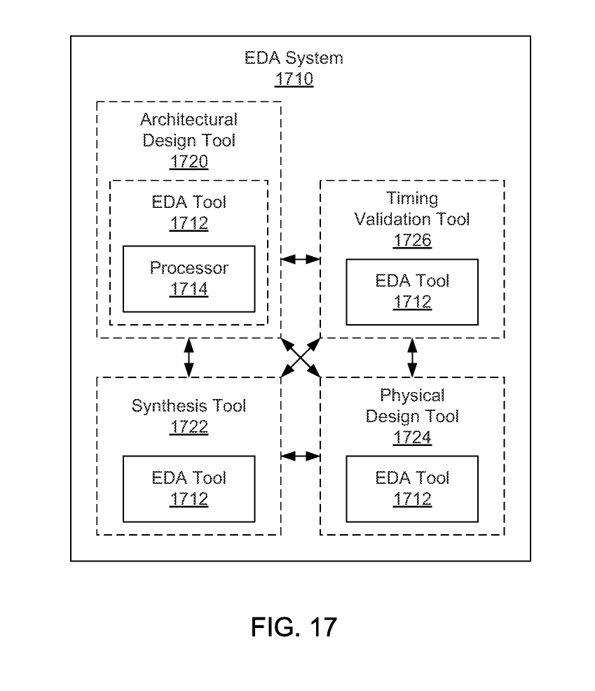

FIG. 17 illustrates an example electronic design automation (EDA) tool 1712 for a clocked tool flow configured for relative timing architecture generation including a processor 1714. In an example, the processor can be configured to implement the method as described in 1500 of FIG. 15. In another example, the processor can be configured to implement the computer circuitry as described as described in 1600 of FIG. 16.

In an example, the processor 1714 (FIG. 17) can be configured to: Generate an integrated circuit (IC) architecture using a relative timed module; map a relative timing constraint (RTC) on to a relative timed instance of the relative timed module; and generate a delay target for each relative timing constraint. In another configuration, the processor can be configured to recursively change delay targets to eliminate timing violations using a timing closure search algorithm.

In another example, the relative timing constraint (RTC) can be represented by pod [symbol] poc₀+m [symbol] poc₁, where pod is the point of divergence (pod) event, poc₀ is a first point of convergence (poc) event to occur before a second poc event poc₁ for proper circuit operation, and margin m is a minimum separation between the poc₀ and the poc₁. The delay targets can provide a maximum target delay for a first relative event path between the pod event and the first poc event, a minimum target delay for a second relative event path between the pod event and the second poc event, or a margin constraint relating first relative event path to second relative event path with a minimum separation between the first relative event and the second relative event.

In another configuration, the processor can be configured to optimize power and performance of the IC architecture using timing driven optimizations of the relative timed module within the clocked tool flow. In another example, the processor can be configured to: Define endpoints for the relative timing constraint; and determine a timing path between endpoints of the relative timing constraint. Each gate of the IC architecture can be represented in at least one timing path of the IC architecture. In another configuration, the processor can be configured to prevent modification of logic of the relative timed module.

In another example, an electronic design automation (EDA) system 1710 using the EDA tool 1712 can be used to generate an integrated circuit (IC). The EDA system can include an architectural design tool 1720, a synthesis tool 1722, a physical design tool 1724, and a timing validation tool 1726. The architectural design tool can include the EDA tool to design and characterize an integrated circuit (IC) architecture by encoding characterization information, cell library information, and architectural performance targets using a hardware description language (HDL). In an example, the architectural design tool can use Verilog, Hardware Description Language (HDL), or very-high-speed integrated circuits (VHSIC) HDL (VHDL). The synthesis tool can include the EDA tool to generate hardware logic to implement behavior of the HDL. In an example, the synthesis tool can use Synopsys design constraint (.sdc), Design

Compiler, Encounter Register Transfer Level (RTL), Xilinx Integrated Software Environment (ISE), Xilinx Synthesis Tool (XST), Quartus, Synplify, LeonardoSpectrum, or Precision. The physical design tool can include the EDA tool to place and route hardware circuitry based on the hardware logic. In an example, the physical design tool can use Synopsys Integrated Circuit Compiler (ICC), Cadence Encounter Digital Implementation (EDI), or Cadence System on Chip (SoC) Encounter. The timing validation tool can include the EDA tool to verify hardware circuitry for performance, correctness, and yield using speed-independent timing constraints and delay-insensitive timing constraints. In an example, the timing validation tool can use Primetime, Tempus, Modelsim, Eldo, Simulation Program with Integrated Circuit Emphasis (SPICE), Verilog Compiled Simulator (VCS), or Cadence Verilog-L tier extension (Verilog-XL).

Various techniques, or certain aspects or portions thereof, may take the form of program code (i.e., instructions) embodied in tangible media, such as floppy diskettes, compact disc-read-only memory (CD-ROMs), hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a random-access memory (RAM), erasable programmable read only memory (EPROM), flash drive, optical drive, magnetic hard drive, solid state drive, or other medium for storing electronic data. The node and wireless device may also include a transceiver module (i.e., transceiver), a counter module (i.e., counter), a processing module (i.e., processor), and/or a clock module (i.e., clock) or timer module (i.e., timer). One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

It should be understood that many of the functional units described in this specification have been labeled as modules, in order to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays (FPGA), programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “an example” or “exemplary” means that a particular feature, structure, or characteristic described in connection with the example is included in at least one embodiment of the present invention. Thus, appearances of the phrases “in an example” or the word “exemplary” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as defacto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of layouts, distances, network examples, etc., to provide a thorough understanding of embodiments of the invention. One skilled in the relevant art will recognize, however, that the invention can be practiced without one or more of the specific details, or with other methods, components, layouts, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. An electronic design automation (EDA) tool for clocked tool flows configured for generating a relative timing architecture using a relative timed module, having computer circuitry configured to:
generate a hardware description language (HDL) integrated circuit (IC) architecture using the relative timed module;
map a relative timing constraint (RTC) on to a relative timed instance of the relative timed module; and
generate a timing target for each relative timing constraint.

2. The computer circuitry of claim 1, wherein the computer circuitry is further configured to:
iteratively modify the timing targets of the relative timing constraints until no negative timing slacks occur in the HDL IC architecture, wherein the negative timing slacks represent timing violations.

3. The computer circuitry of claim 2, wherein the computer circuitry configured to iteratively modify the timing targets is further configured to:
converge negative timing slacks for both clocked timing delay paths and relative timing delay paths.

4. The computer circuitry of claim 2, wherein the computer circuitry configured to iteratively modify the timing targets is further configured to:
add delay elements into the HDL IC architecture to satisfy the relative timing constraint.

5. The computer circuitry of claim 2, wherein the computer circuitry configured to iteratively modify the timing targets is further configured to:
optimize power and performance of the HDL IC architecture using timing driven optimizations of the relative timed module within the clocked tool flows.

6. The computer circuitry of claim 1, wherein:
the computer circuitry configured to map the relative timing constraint is further configured to define endpoints for the relative timing constraint; and
the computer circuitry configured to generate the timing target is further configured to determine a timing arc between endpoints across a timing path of the relative timing constraint, wherein one of a composite of the timing arcs pass through each gate of the IC architecture.

7. The computer circuitry of claim 1, wherein:
the relative timing constraint (RTC) is represented by pod [symbol] poc₀+m [symbol] poc₁, where pod is the point of divergence (pod) event, poc₀ is a first point of convergence (poc) event to occur before a second poc event poc₁ for proper circuit operation, and margin m is a minimum separation between the poc₀ and the poc₁; and
the timing targets provides a maximum target delay for a first relative event path between the pod event and the first poc event, a minimum target delay for a second relative event path between the pod event and the second poc event, or a margin target delay representing a minimum separation between the first relative event and the second relative event.

8. The computer circuitry of claim 1, wherein the computer circuitry is further configured to:
design and characterize the relative timed module.

9. The computer circuitry of claim 1, wherein the computer circuitry configured to generate the timing target for each relative timing constraint is based on an architecture power target or an architecture performance target.

10. The computer circuitry of claim 1, wherein the EDA tool is a synthesize tool, an optimization tool, a physical design tool, a physical route and placement tool, or a timing validation tool.

11. The computer circuitry of claim 1, wherein the relative timed module generates a behavioral HDL IC architecture or structural HDL IC architecture by encoding the design into Verilog, HDL, or very-high-speed integrated circuits (VHSIC) HDL (VHDL).

12. An electronic design automation (EDA) tool for a clocked tool flow configured for relative timing architecture generation, comprising:
a processor to:
generate an integrated circuit (IC) architecture using a relative timed module;
map a relative timing constraint (RTC) on to a relative timed instance of the relative timed module; and
generate a delay target for each relative timing constraint.

13. The EDA tool of claim 12, wherein the processor is further configured to:
recursively change delay targets to eliminate timing violations using a timing closure search algorithm.

14. The EDA tool of claim 12, wherein:
the relative timing constraint (RTC) is represented by pod [symbol] poc₀+m [symbol] poc₁, where pod is the point of divergence (pod) event, poc₀ is a first point of convergence (poc) event to occur before a second poc event poc₁ for proper circuit operation, and margin m is a minimum separation between the poc₀ and the poc₁; and
the delay targets provides a maximum target delay for a first relative event path between the pod event and the first poc event, a minimum target delay for a second relative event path between the pod event and the second poc event, or a margin constraint relating first relative event path to second relative event path with a minimum separation between the first relative event and the second relative event.

15. The EDA tool of claim 12, wherein the processor is further configured to:
optimize power and performance of the IC architecture using timing driven optimizations of the relative timed module within the clocked tool flow.

16. The EDA tool of claim 12, wherein the processor is further configured to:
define endpoints for the relative timing constraint; and
determine a timing path between endpoints of the relative timing constraint, wherein each gate of the IC architecture is represented in at least one timing path of the IC architecture.

17. The EDA tool of claim 16, wherein the processor is further configured to:
prevent modification of logic of the relative timed module.

18. An electronic design automation (EDA) system using the EDA tool of claim 12 to generate an integrated circuit (IC), comprising:
an architectural design tool including the EDA tool of claim 12 to design and characterize an integrated circuit (IC) architecture by encoding characterization information, cell library information, and architectural performance targets using a hardware description language (HDL);
a synthesis tool including the EDA tool of claim 12 to generate hardware logic to implement behavior of the HDL;
a physical design tool including the EDA tool of claim 12 to place and route hardware circuitry based on the hardware logic; and
a timing validation tool including the EDA tool of claim 12 to verify hardware circuitry for performance, correctness, and yield using speed-independent timing constraints and delay-insensitive timing constraints.

19. The EDA system of claim 18, wherein the architectural design tool uses Verilog, Hardware Description Language (HDL), or very-high-speed integrated circuits (VHSIC) HDL (VHDL); the synthesis tool uses Synopsys design constraint (.sdc), Design Compiler, Encounter Register Transfer Level (RTL), Xilinx Integrated Software Environment (ISE), Xilinx Synthesis Tool (XST), Quartus, Synplify, LeonardoSpectrum, or Precision; the physical design tool uses Synopsys Integrated Circuit Compiler (ICC), Cadence Encounter Digital Implementation (EDI), or Cadence System on Chip (SoC) Encounter; and the timing validation tool uses Primetime, Tempus, Modelsim, Eldo, Simulation Program with Integrated Circuit Emphasis (SPICE), Verilog Compiled Simulator (VCS), or Cadence Verilog-L tier extension (Verilog-XL).

20. A method for generating a relative timing architecture enabling use of clocked electronic design automation (EDA) tool flows, comprising:
generating an integrated circuit (IC) architecture using a relative timed module;
mapping relative timing constraints (RTC) on to a relative timed instance of the relative timed module; and
generating a delay value for each relative timing constraint.

21. The method of claim 20, wherein generating the delay value for each relative timing constraint further comprises:
iteratively modifying the delay values of the relative timing constraints until no timing violations occur in the IC architecture thereby generating a closed timing solution.

22. The method of claim 20, further comprising:
optimizing power and performance of the IC architecture using timing driven optimizations of the relative timed module within clocked tool flows, wherein optimizing power and performance include timed separation of events, canopy graphs, visualization techniques, voltage reduction, or power gating.

23. The method of claim 20, wherein:
the relative timing constraint (RTC) is represented by pod [symbol] poc₀+m [symbol] poc₁, where pod is the point of divergence (pod) event, poc₀ is a first point of convergence (poc) event to occur before a second poc event poc₁ for proper circuit operation, and margin m is a minimum separation between the poc₀ and the poc₁; and
the delay values provides a maximum target delay for a first relative event path between the pod event and the first poc event, a minimum target delay for a second relative event path between the pod event and the second poc event, and a margin target delay representing a minimum separation between the first relative event and the second relative event.

24. The method of claim 20, wherein mapping relative timing constraints and generating the delay value for each relative timing constraint further comprises:
defining endpoints for the relative timing constraint; and
determining a timing path between endpoints of the relative timing constraint, wherein each gate of the IC architecture is represented in at least one timing path of the IC architecture.

25. The method of claim 20, further comprising:
preventing logic modification of the relative timed module or relative timed instance.

26. At least one non-transitory machine readable storage medium comprising a plurality of instructions adapted to be executed to implement the method of claim 20.
